(19) United States
(12) Patent Application Publication
(10) Pub. No.: US 2013/0284969 A1
(43) Pub. Date: Oct. 31, 2013

(54) R-FE-B SINTERED MAGNET WITH ENHANCED MECHANICAL PROPERTIES AND METHOD FOR PRODUCING THE SAME

(71) Applicants: Young-Do Kim, Seoul (KR); Se-Hoon Kim, Seoul (KR); Jin-Woo Kim, Gyeongsangnam-do (KR)

(72) Inventors: Young-Do Kim, Seoul (KR); Se-Hoon Kim, Seoul (KR); Jin-Woo Kim, Gyeongsangnam-do (KR)

(73) Assignee: INDUSTRY-UNIVERSITY COOPERATION FOUNDATION, HANYANG UNIVERSITY, Seoul (KR)

(21) Appl. No.: 13/979,427

(22) PCT Filed: Jan. 6, 2012
(86) PCT No.: PCT/KR2010/000139

§ 371 Date: Jul. 12, 2013

(30) Foreign Application Priority Data
Jan. 25, 2011 (KR) 10-2011-0007297
Nov. 30, 2011 (KR) 10-2011-0126640

(51) Int. Cl. H01F 1/01

(52) U.S. Cl. CPC H01F 1/01
USPC 252/62.57; 264/611

(57) ABSTRACT

Disclosed are an R—Fe—B sintered magnet and a method for producing the same. More specifically, provided is an R—Fe—B (R=Nd, Dy, Pr, Tb, Ho, La, Ce, Sm, Gd, Er, Tm, Yb, Lu or Th) sintered magnet having a structure in which R₂Fe₁₄B crystal grains as major phases are surrounded with R-rich phases, wherein a dihedral angle between two adjacent R₂Fe₁₄B crystal grains and the R-rich phase contacting the R₂Fe₁₄B crystal grains is 70° or less in a triple junction formed by the R₂Fe₁₄B crystal grains. The sintered magnet maintains a high coercive force and exhibits improved mechanical properties and is thus applicable to motors or permanent magnets used at high temperatures.

### TECHNICAL FIELD

The present invention relates to an R—Fe—B sintered magnet that maintains high coercive force and exhibits improved mechanical properties and is thus applicable to motors or permanent magnets used under high-temperature conditions.

### BACKGROUND ART

Since Nd-based rare earth magnets having a maximum energy product of 35 MGOe were first developed by M. Sagawa in 1983[M. Sagawa, S. Fujimura, N. Tpgawa and Y. Matsuura, J. Appl. Phys., 55 (1984) 2083], Nd-based rare earth permanent magnets have been actively researched in Japan, the U.S. and Europe due to considerably superior magnetic properties thereof.

In particular, in recent decades, energy reduction and concern over the environment have drawn considerable attention as important issues and interest in rare earth-based permanent magnets for driving motors and generators of hybrid/hydrogen fuel-powered automobiles has increased and the demand therefor has increased accordingly [Y. Kanejo, F. Kuniyoshi and N. Ishigaki, J. Alloys and Compds., 408-412 (2006) 1344].

Accordingly, a great deal of research to increase usage temperature of Nd-based permanent magnets to about 200° C. by improving coercive force of Nd-based permanent magnets through novel alloy designs and process optimization is actively underway.

Nd—Fe—B sintered magnets developed to date have a theoretical maximum energy product of about 64 MGOe. However, high-coercive force Nd—Fe—B sintered magnets have a low Curie temperature of about 315° C. Deterioration in magnetic performance becomes serious at high temperature due to the low Curie temperature, the greatest problem of Nd-based permanent magnets, and the sintered magnets are unsuitable for use in next-generation automobile motors.

In order to solve the problems caused by the high coercive force and to apply Nd-based permanent magnets to motors for next-generation automobiles, a great deal of research into sintered magnets having a high coercive force to which a small amount of heavy rare earth elements such as Dy or Tb having a high anisotropic field is added, is actively underway.

However, heavy rare earths are present in small amounts on earth and supply thereof is thus limited. Accordingly, there is an increasing need to improve microstructures of materials and thereby improving characteristics thereof in order to minimize content of heavy rare earth elements such as Dy and Tb.

Generally, in a case of permanent magnets having nucleation-type coercive force mechanisms, impurities, defects or the like present in magnetotactic phases may be readily formed into demagnetized magnetic nuclei. For this reason, coercive force is decreased. Meanwhile, domain wall pinning by crystal grain systems occurs. The distribution level of R-rich materials, nonmagnetic materials constituting crystal grain systems and fractions of crystal grain systems are considerably essential for coercive force.

The true density of Nd—Fe—B sintered magnets is obtained by densification using sintering at a temperature of 1,000 to 1,250° C. The sintering enables nonmagnetic Nd-rich materials to be dispersed at the interface of ferromagnetic crystal grains in sintered magnets, inhibits magnetic exchange between ferromagnetic materials and thereby improves coercive force. For example, H. J. Wang et al., discloses that impact stability is increased by 137% when Nd is 22 at % and impact stability can be improved through the increased Nb-rich materials in the process of production of Nd—Fe—B sintered magnets [H. J. Wang et al., “Sintered Nd—Fe—B magnets with improved impact stability”, Journal of Magnetism and Magnetic Materials 307 (2006) 268-272].

In spite of the advantage of high coercive force, Nd—Fe—B sintered magnets have been utilized in limited applications, since they have a high bending strength of 200 to 350 MPa and a high fracture toughness of 2.5 to 4.0 MPa·m^{1/2}, as compared to ferrite (having a bending strength of 50 to 90 MPa and a fracture toughness of 1 to 1.2 MPa·m^{1/2}) or SmCO₅ (a bending strength of 120 MPa and a fracture toughness of 1.9 to 2.0 MPa·m^{1/2}), but have a low fracture toughness, as compared to Alnico (having a bending strength of 20 to 82 MPa and a fracture toughness of 13 to 14 MPa·m^{1/2}) and are thus considerably vulnerable to impact. Accordingly, an attempt to improve mechanical properties by controlling a variety of sintering processes has been made.

Wei Liu et al., performed sintering at 1060° C. for 2 hours and heating at 520° C. for 90 minutes [Wei Liu et al., Mechanical properties and fracture mechanism study of sintered Nd—Fe—B alloy, Journal of Alloys and Compounds Volume 458, Issues 1-2, 30 Jun. 2008, Pages 292-296], and H. J. Wang et al., suggest sintering at a temperature of 1087° C. for 2 hours and heating at 900° C. for one hour and at 600° C. for 2 hours [H. J. Wang et al., Anisotropy of mechanical properties in sintered Nd—Fe—B magnets, Journal of Magnetism and Magnetic Materials Volume 303, 3 Mar. 2006, Pages e392-e3951. With respect to the R—Fe—B sintered magnets obtained by sintering, crystal grains are grown (to 1.5-fold or more of initial powder size) during sintering and abnormal grains are grown (to 2-fold or more of normal crystal grain size) during sintering, thus inhibiting even distribution of R-rich materials, nonmagnetic materials constituting crystal grain systems and causing R-rich phases to be present at a locally limited triple junction. As a result, Fe—B sintered magnets have poor mechanical properties, are considerably vulnerable to vibration, impact and the like, have bad processability and are unsuitable for applications in which they will be subject to considerable physical and thermal force, thus inevitably being limited in terms of application.

Accordingly, in order to solve the vulnerability to vibration, thermal impact and physical impact and apply the sintered magnets to various industries, Fe—B sintered magnets that exhibit improved physical properties due to incorporation of elements such as Al, Cu, Ga and Nb are used.

W. F. Li et al., suggest a series of processes including sintering, addition of Cu and thermal treatment at 600° C. in the production of Nd—Fe—B sintered magnets. W. F. Li et al., disclose that a Cu-rich layer and a 3-nm thick Nd-rich phase are formed around crystal grains through sintering [W. F. Li et al., “Effect of post-sinter annealing on the coercivity and microstructure of Nd—Fe—B permanent magnets”, Acta Materialia 57 (2009) 1337-1346]. However, addition of these elements causes deterioration in magnetic properties, thus limiting addition thereof. Moreover, addition of elements requires densification to improve density and at least two thermal treatment processes, thus making the process complicated and deteriorating magnetic properties thereof due to addition of impurities.

The inventors of the present invention have performed a variety of research to effectively control microstructures of sintered magnets, in particular, R-rich phases and thereby improve properties of sintered magnets.

The present inventors suggested in Korean Patent Laid-open No. 2010-97580 that coercive force can be improved by performing repeated thermal treatment processes at 300 to 600° C. after sintering in the production of R—Fe—B sintered magnets, to allow R-rich phases to more rapidly move to Nd₂Fe₁₄B major crystals and evenly surround crystal grain systems. The sintered magnets thus obtained can secure improved coercive force, but for example have a problem of readily cracking upon exposure to exterior impact due to low mechanical strength.

Accordingly, the present inventors performed research into novel sintered magnets in which cracks do not readily occur by limiting the thickness of R-rich phases surrounding crystal grain systems and a method for producing the same. As a result, the present invention has been completed.

### DISCLOSURE OF INVENTION

### Technical Problem

Accordingly, the inventors of the present invention intensely tried to develop R—Fe—B sintered magnets that maintain high coercive force and exhibit improved mechanical properties. As a result, the present inventors confirmed that bending strength and fracture toughness can be improved by variation in microstructures of sintered magnets through control of sintering and thermal treatment, thus completing the present invention.

It is one object of the present invention to provide a sintered magnet with improved coercive force and improved mechanical properties through variation in microstructure of the sintered magnet.

It is another object of the present invention to provide a method for producing a sintered magnet having such characteristics and enabling simplification of the overall process.

### Solution to Problem

In accordance with an aspect of the present invention, the above and other objects can be accomplished by the provision of an R—Fe—B (R=Nd, Dy, Pr, Tb, Ho, La, Ce, Sm, Gd, Er, Tm, Yb, Lu or Th) sintered magnet having a structure in which R₂Fe₁₄B crystal grains as major phases are surrounded with R-rich phases, wherein a dihedral angle between two adjacent R₂Fe₁₄B crystal grains and the R-rich phase contacting the R₂Fe₁₄B crystal grains is 70° or less in a triple junction formed by the R₂Fe₁₄B crystal grains.

In accordance with another aspect of the present invention, provided is a method for producing the R—Fe—B sintered magnet according to the present invention by sintering and thermal treatment using a R—Fe—B (R=Nd, Dy, Pr, Tb, Ho, La, Ce, Sm, Gd, Er, Tm, Yb, Lu, Th) powder, wherein the sintering and thermal treatment are repeated two or more times.

### Advantageous Effects of Invention

The Nd—Fe—B sintered magnet according to the present invention maintains high coercive force and exhibits improved mechanical properties such as bending strength and fracture toughness.

The sintered magnet may be applied to motors or permanent magnets used at high temperatures including motors for hybrid automobiles and to permanent magnets used for satellites due to improved reliability under harsh environments.

### BRIEF DESCRIPTION OF DRAWINGS

The above and other objects, features and other advantages of the present invention will be more clearly understood from the following detailed description taken in conjunction with the accompanying drawings, in which:

FIG. 1 is a schematic view illustrating a crystal structure of a sintered magnet according to the present invention;

FIG. 2 is a schematic view illustrating processes associated with a method for producing the sintered magnet of the present invention;

FIG. 3 is a schematic view illustrating variation in microstructure by sintering and thermal treatment of the sintered magnet according to the present invention, and specifically, FIG. 3(A) shows behaviors of crystal grains during sintering and FIG. 3(B) shows behaviors of crystal grains during thermal treatment;

FIG. 4 is a graph showing a size of crystal grains of sintered magnets produced through cyclic sintering/thermal treatment in Example 1;

FIG. 5(A) is an SEM (scanning electron microscope) image showing sintered magnets obtained in Comparative Example 1 and FIGS. 5(B) to 5(D) are SEM images showing sintered magnets obtained in Example 1;

FIG. 6(A) is a TEM (transmission electron microscope) image of a sintered magnet obtained in Comparative Example 1, and FIGS. 6(B) to 6(D) are TEM images of sintered magnets obtained in Example 1;

FIG. 7(A) is a TEM (transmission electron microscope) image showing a microstructure on the interface between crystal grains of sintered magnet prepared in Comparative Example 1, and FIG. 7(B) is an enlarged image thereof;

FIG. 8(A) is a TEM (transmission electron microscope) image showing a microstructure on the interface between crystal grains of sintered magnet prepared in Example 1, and FIGS. 8(B) and 8(C) are enlarged images thereof;

FIG. 9(A) is a graph showing variation in dihedral angle depending on the number of sintering/thermal treatment cycles of Comparative Example 1 and Example 1 and FIG. 9(B) is a schematic view showing a measured region;

FIG. 10 is an X-ray diffraction (XRD) spectrum of sintered magnets prepared through 10 cycles obtained in Example 1;

FIG. 11(A) is an image of a sintered magnet produced in Comparative Example 1, FIG. 11(B) is an image of a sintered magnet produced by 2-cycle sintering/thermal treatment, FIG. 11(C) is an image of a sintered magnet produced by 6-cycle sintering/thermal treatment, and FIG. 11(D) is an image of a sintered magnet produced by 10-cycle sintering/thermal treatment;

FIG. 12 is a graph showing size and relative density of crystal grains of sintered magnets measured in FIG. 11;

FIG. 13 is a graph showing bending strength of sintered magnets produced in Comparative Example 1 and Example 1;

FIG. 14 is a graph showing variation in tensile strength of sintered magnets according to cyclic sintering/thermal treatment processes of Comparative Example 1 and Example 1;

FIG. 15 is a SEM (scanning electron microscope) image showing a propagation length of cracks of FIG. 14;

FIG. 16 is X-ray diffraction (XRD) spectra of sintered magnets produced in Comparative Example 1 and Example 1; and

FIG. 17 is a graph showing variation in coercive force of sintered magnets produced in Comparative Example 1 and Example 1.

### BEST MODE FOR CARRYING OUT THE INVENTION

Hereinafter, the present invention will be described in detail.

Mechanical properties of R—Fe—B sintered magnets depend on characteristics of R₂Fe₁₄B crystal grains and are thus considerably poor, since R-rich phases have irregular microstructures and are concentrated in local regions such as triple junctions. Accordingly, the present invention suggests sintered magnets that exhibit high coercive force and improved mechanical properties through improvement in interfacial properties between R-rich phases and R₂Fe₁₄B ferromagnetic crystal grains.

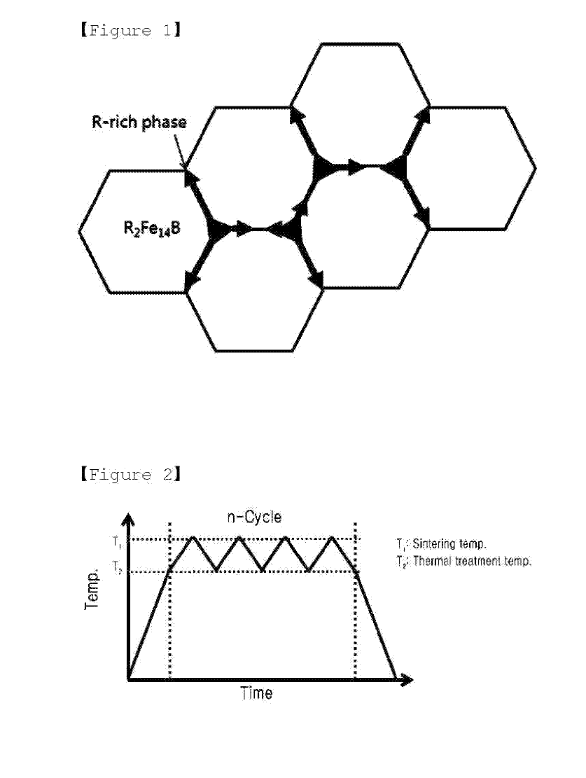

FIG. 1 is a schematic view illustrating a crystal structure of a sintered magnet according to the present invention.

Referring to FIG. 1, an R—Fe—B (R=Nd, Dy, Pr, Tb, Ho, La, Ce, Sm, Gd, Er, Tm, Yb, Lu or Th) sintered magnet has a structure in which R₂Fe₁₄B crystal grains as major phases are surrounded by R-rich phases. At this time, the sintered magnet is represented by Rₓ—Fe_{y}—B_{z} (x=11.8 to 15.5, y=100−(x+z), z=5.8 to 6.2, at %) and a part of Fe may be substituted by other transition metal elements (for example, Co or Ni). This alloy may contain about 0.01 to about 3.0 at % of at least one element (TM, transition metal) selected from the group consisting of Co, Cu, Ni, Al, Si, Ti, V, Cr, Mn, Zn, Ga, Zr, Nb, Mo, Ag, In, Sn, Hf, Ta, W, Pb and Bi.

The improvement in interfacial properties between crystal grains and R-rich phases allows the interface between highly brittle crystal grains to be evenly surrounded by relatively tough R-rich phases and imparts high resistance to applied stress. As R-rich phases surround the crystal grains more thickly, the effects of improvement in mechanical properties can be further improved.

A dihedral angle can be measured by measurement of a degree to which the R-rich phases surround crystal grains. A dihedral angle is defined as an angle at which one plane forms with another plane, more specifically, an angle between two perpendiculars drawn on two sides that contact each other in a vertical direction from one point on a straight line where the two sides meet. A triple junction in the sintered magnets means a region present in R-rich phases where three crystal grains contact one another. At this time, when crystal grains and R-rich phases are seen from the plane, a dihedral angle may be an angle between crystal grains and R-rich phases based on the triple junction. From the dihedral angle, contact properties indicating a degree to which crystal grains contact R-rich phases can be expected. That is, as dihedral angle decreases, wettability between R-rich phases and crystal grains improves and R-rich phases more efficiently permeate into the interface between crystal grains.

A sintered magnet manufactured by a common sintering and thermal treatment method, as shown in FIG. 6, has a structure in which R-rich phases thinly surround crystal grains, while the sintered magnet of the present invention has a structure in which R-rich phases thickly surround crystal grains. The sintered magnet of Comparative Example 1 produced by a common method has a dihedral angle of 95°, while the sintered magnet according to the present invention has a dihedral angle of 70° or less, preferably 55° or less, which indicates that R-rich phases effectively permeate into the interface between crystal grains and more easily isolate the crystal grains.

In the sintered magnet of the present invention with a small dihedral angle at the interface, the thickness of R-rich phases present between the crystal grains further increases. When the thickness increases, crystal grains are considered to be respective grains and coercive force is increased. That is, sintered magnets in the related art also have a structure in which crystal grains are surrounded with R-rich phases, and, in this structure, thickness of crystal grain interfaces is considerably small (at maximum, a level lower than 5 nm) and the crystal grains are not sufficiently surrounded with R-rich phases. In this case, all grains of crystal grains are considered to be one grain, that is, crystal grains increase in size and coercive force thus decreases. However, the sintered magnet of the present invention has a crystal grain size of 6.0 to 7.0 μm, which is unsuitable for use in sintered magnets, and sufficiently secures the gap between crystal grains through R-rich phases, thus increasing coercive force.

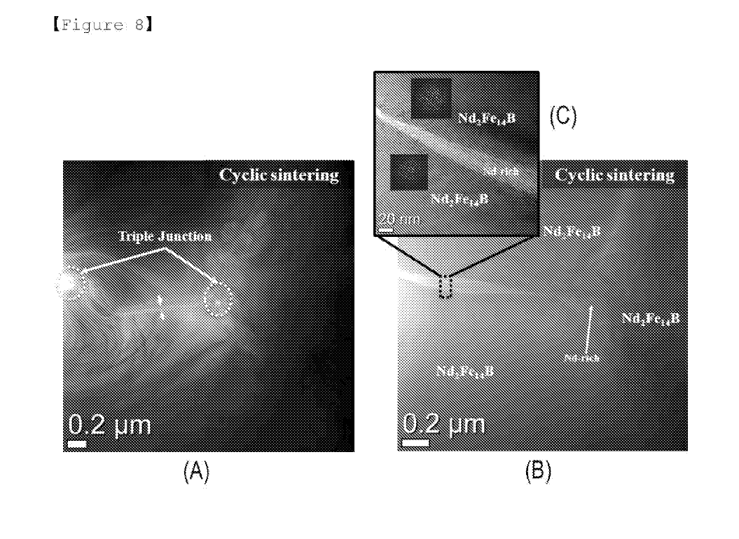

The gap between crystal grains, that is, the thickness of R-rich phases at the interface, is at least 10 nm, preferably 10 to 50 nm, more preferably 10 to 20 nm. The R-rich phases present at the interface of crystal grains exhibit superior toughness as compared to crystal grains, as can be seen from the observation results of crack passage in FIG. 8, as thickness of R-rich phases increases, crack length decreases. From the aforementioned results, it can be seen that mechanical properties of sintered magnets are improved due to R-rich phases present at the interface of crystal grains. At this time, R-rich phases are present at a predetermined area ratio, preferably, 5 to 15% with respect to the total area of crystal grains (R₂Fe₁₄B).

In particular, the sintered magnet of the present invention is present as a precipitate of η-phase (R_{1.1}Fe₄B₄), in addition to R-rich phases inside the triple junction.

R—Fe—B sintered magnets in the related art disclose presence of η-phase, but the disclosed η-phase is dissolved and present in R-rich phases and the content thereof is considerably small, several ppm, and is thus almost undetectable.

The η-phase observed in the present invention is present together with the R-rich phase, as a crystal grain precipitated in the triple junction, rather than in a dissolved state. Specifically, as can be seen from the chemical structure, the η-phase contains a higher amount of boron (B) than the major phase and the R-rich phase, thus causing a boron element to move to, not R-rich phase, but η-phase during sintering and allowing the η-phase to be crystallized and precipitated at the triple junction, instead of being dissolved in the R-rich phases.

As known in the art, when R—Fe—B powders are sintered, crystal grain major phases are formed, and, as sintering is further performed, the size of crystal grain gradually increases through movement of the crystal grain system. In the present invention, η-phase present at the triple junction between the crystal grains inhibits movement of the crystal grain system and suppresses growth of the crystal grain system. The η-phase is a nonmagnetic phase, which prevents deterioration in coercive force by sintering based on suppression of growth of crystal grains without directly affecting magnetic properties of sintered magnets.

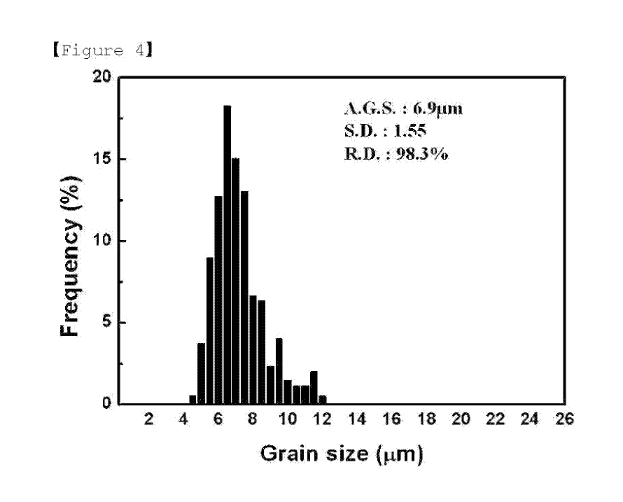

Preferably, from Test example 7 of the present invention, the size of crystal grains depending on the cycle number of sintering/thermal treatment can be confirmed. As can be seen from FIG. 12, showing the results of Test example 7, crystal grains are slightly grown depending on the cycle number, but the size thereof is maintained in the range of 6.0 to 8.0 μm. In addition, as can be seen from FIG. 4, a standard deviation of the size of crystal grains is ±1.55 or less, which indicates that crystal grains are also uniformly grown.

The microstructure of the sintered magnet of the present invention can be controlled by a variety of process conditions, in particular, sintering temperature, cycle number of sintering and thermal treatment. Specifically, by producing sintered magnets under controlled sintering and thermal treatment conditions, R-rich phases can be distributed such that they thickly surround the interface of R₂Fe₁₄B ferromagnetic crystal grains. In particular, this can be carried out by repeating the sintering and thermal treatment processes.

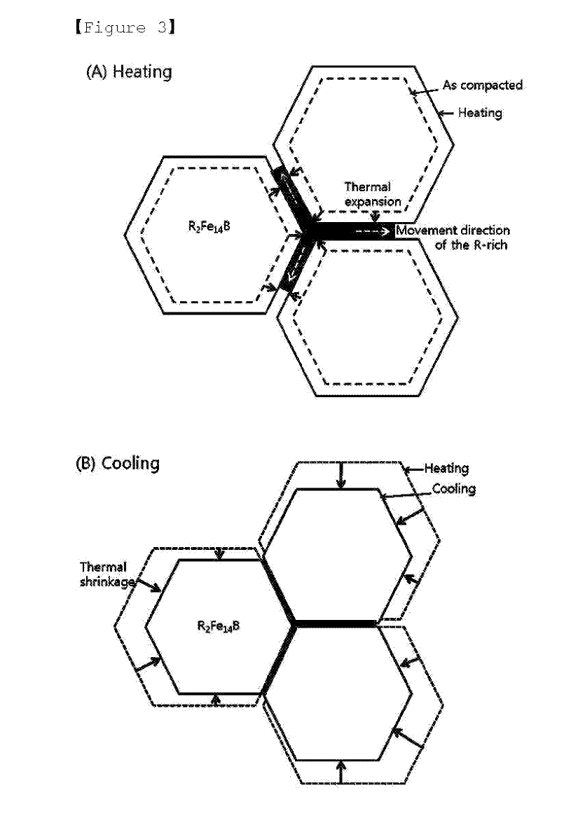

FIG. 2 is a schematic view illustrating processes associated with a method for producing the sintered magnet of the present invention. Referring to FIG. 2, sintering is performed at a temperature of T₁, thermal treatment is performed at a decreased temperature of T₂, sintering is performed at T₁ again and thermal treatment is performed at T₂ again.

Preferably, sintering (heating) is carried out at T₁ of 1050 to 1200° C. and thermal treatment (cooling) is carried out at T₂ of 750 to 1000° C. which is lower than T₁. At this time, the sintering and thermal treatment processes are repeated two or more times and are performed until the density of sintered magnets reaches 98% or more. Preferably, the sintering/thermal treatment (heating/cooling) is performed 2 to 10 cycles, most preferably 10 cycles. At this time, the total process time involved in the cyclic sintering/thermal treatment processes depends on common sintering and thermal treatment times.

The cycle number of heating and cooling of the sintering process depends on the difference between the two temperatures, thermal treatment rate and cooling rate. That is, as the difference between the two temperatures increases and the thermal treatment rate and cooling rate increase, variation in microstructures of R-rich phases can be further induced and densification can be facilitated. Preferably, the difference between the two temperatures is 70° C. or more, preferably 100 to 200° C., and the thermal treatment rate and cooling rate are within a range of 5 to 15° C./min. When the difference between sintering and thermal treatment temperatures is excessively small, expansion and shrinkage of crystal grains are not easily controlled and, as a result, capillary attraction caused by expansion and shrinkage of crystal grains is low and R-rich phases cannot sufficiently move to the interface between crystal grains and the effects of improvement in mechanical properties cannot be expected. These behaviors may also be applied to heating and cooling rates and interpreted similarly.

The sintering/thermal treatment process is preferably carried out under vacuum, if necessary, and is carried out at a pressure of 1×10⁻⁴ to 1×10⁻⁷ Torr. At this time, the overall process is performed until densification is completely finished in order to obtain optimal mechanical properties and the overall process time is, for example, 1 to 100 hours. When heating and cooling are repeated after densification is finished, residual stress is present in sintered materials and mechanical properties are thus deteriorated.

FIG. 3 is a schematic view illustrating variation in microstructure by sintering and thermal treatment of the sintered magnet of the present invention. FIG. 3(A) shows behaviors of crystal grains during sintering and FIG. 3(B) shows behaviors of crystal grains during thermal treatment.

Referring to FIG. 3(A), during sintering, an initially formed material is thermally expanded and crystal grains are grown (crystal grains are grown from the size represented by dotted lines to the size represented by un-dotted lines). At this time, R-rich phases are present in a liquid state at a sintering temperature and penetrate into the interface between crystal grains based on capillary attraction. As shown in FIG. 3(B), as thermal treatment is performed, that is, as temperature decreases, crystal grains shrink (crystal grains shrink from the size represented by dotted lines to the size of undotted lines), capillary attraction at the interface of crystal grains is rapidly decreased. The rapid decrease in capillary attraction causes occurrence of compressive stress and allows R-rich phases present at the interface of crystal grains to more deeply permeate into the crystal grains. Based on the thermal expansion by sintering and thermal shrinkage by thermal treatment, a further densification driving force occurs, R-rich phases are more widely distributed at the interface between crystal grains and direct contact between R₂Fe₁₄B ferromagnetic phases is thus inhibited, and deterioration in magnetic properties by interexchange effects can be minimized and mechanical properties of sintered magnets are thus improved due to high toughness of R-rich phases. In addition, through repeated thermal shrinkage, growth of crystal grains is inhibited and the size of crystal grains is not increased, as compared to an R—Fe—B powder used as a raw material.

Growth of crystal grains of sintered magnets produced by low-temperature sintering is inhibited and the size of crystal grains is not increased, as compared to the R—Fe—B powder used as a raw material, and the crystal grains are grown at a level of 150% or less.

Specifically, when a R—Fe—B powder having a grain size of 0.2 to 10.0 μm, preferably 1.0 to 5.0 μm, is used, the grain size of finally produced R—Fe—B sintered magnets is 0.25 to 12.5 μm, preferably 1.25 to 6.2 μm. That is, crystal grains of sintered magnets are grown to a size of 150%, preferably 125% or less of the raw material.

FIG. 4 is a graph showing a size of crystal grains of sintered magnet produced in Example 1. From FIG. 4, it can be seen that an average size of crystal grains of sintered magnet produced using a 5 μm raw material powder is 6.9 μm and after sintering, crystal grains are grown at a level of 140% or less.

Referring to FIG. 6, as can be seen from the results observed by a scanning electron microscope, R-rich phases (white) are more evenly distributed around R₂Fe₁₄B phases and are greatly increased to 10 nm or more, while the gap between R₂Fe₁₄B phases of rare earth sintered magnets prepared by a general sintering process is about 2 to about 5 nm (Y. Shinba et al., Transmission electron microscopy study on Nd-rich phase and grain boundary structure of Nd—Fe—B sintered magnets, Journal of Applied Physics Volume 97, 9 February, Pages 053504).

As a result, the sintered magnet of the present invention has a relative density of 98% or more, a bending strength of 400 to 600 MPa, a fracture toughness of 5.0 to 7.0 MPa·m^{1/2} and a coercive force of 8 to 36 kOe. The bending strength and fracture toughness of the present invention are increased to about 2 times and about 2 times or more, respectively, as compared to bending strength (200 to 350 MPa) and fracture toughness (2.5 to 4.0 MPa·m^{1/2}) of conventional R—Fe—B sintered magnets.

The sintered magnets thus prepared have a high coercive force and are thus useful as magnets for hybrid cars and next-generation electric automobiles. More specifically, the sintered magnets are widely used in fields requiring high-performance magnetic properties such as motors for automobiles, MRIs, electric generators, robots, speakers, voice coil motors (VCMs), electronics and toys.

### Mode for the Invention

Now, the present invention will be described in more detail with reference to the following Examples. These examples are only provided to illustrate the present invention and should not be construed as limiting the scope or spirit of the present invention.

### Example 1

In order to prepare a specimen having an alloy composition of Nd_{12.8}Dy₂Fe_{76.4}Co_{1.89}Cu_{0.19}Al_{0.52}Nb_{0.3}B_{5.9} (at %) in which Nd:12.8, Dy:2.0, B:5.9, Co:1.89, Cu:0.19, Nb:0.3, Al:0.52 balance:Fe (at %), respective components were melted at 1600° C. and alloy strips were produced by a strip casting method. The alloy strips thus produced were subjected to hydrogenation/dehydrogenation to form microcracks in crystal grain systems, ground by jet milling and screened into a powder having an average grain diameter (D₅₀) of 5.0 μm.

Then, the powder was molded into a material with a size of 20×12×15 mm³ under a static magnetic field of 20 kOe using a magnetic field molding machine. At this time, molding pressure was 1.2 tons and a relative density of the molded material was 48%.

Then, the molded material was sintered in a vacuum furnace at a vacuum of 2.4×10⁻⁶ torr or less, and heating and cooling in a range of 950° C. to 1050° C., respectively, and sintering and thermal treatment in which the temperature was elevated and lowered at a rate of 10° C./min, respectively, were repeated 10 times or less in order to induce microstructures such that liquid (Nd,Dy)-rich phases were uniformly distributed in (Nd,Dy)₂Fe₁₄B crystal grain systems using thermal expansion and shrinkage depending on difference in temperature. At this time, the process including sintering/thermal treatment was performed for 4 hours.

### Example 2

A sintered magnet was produced in the same manner as in Example 1 except that an alloy composition of Pr_{12.8}Dy₂Fe_{76.4}Co_{1.89}Cu_{0.19}Al_{0.52}Nb_{0.3}B_{5.9} in which Pr:12.8, Dy:2.0, B:5.9, Co:1.89, Cu:0.19, Nb:0.3, Al:0.52, balance:Fe (at %) was used.

### Example 3

A sintered magnet was produced in the same manner as in Example 1 except that an alloy composition of Tb_{0.4}Nd_{8.9}Dy_{3.1}Fe₇₈Co_{2.7}Cu_{0.1}Al_{0.9}B_{5.9} in which Tb:0.4, Nd:8.9, Dy:3.1, B:5.9, Co:2.7, Cu:0.1, Al:0.9, balance:Fe (at %) was used.

### Example 4

A sintered magnet was produced in the same manner as in Example 1 except that an alloy composition of Nb_{0.6}Nd_{8.3}Dy_{3.5}Fe₇₈Co_{2.7}Cu_{0.1}Al_{0.9}B_{5.9} in which Nb:0.6, Nd:8.3, Dy:3.5, B:5.9, Co:2.7, Cu:0.1, Al:0.9, balance:Fe (at %) was used.

### Comparative Example 1

A sintered magnet was produced in the same manner as in Example 1 except that a sintering process was performed at 1070° C. for 4 hours.

### Test Example 1

Measurement of Size and Relative Density of Crystal Grains

With respect to the sintered magnets that were subjected to the cyclic sintering/thermal treatment process of Example 1, the size and relative density of crystal grains were measured.

FIG. 4 is a graph showing a size of crystal grains of sintered magnets that were subjected to the cyclic sintering/thermal treatment process of Example 1. Referring to FIG. 4, crystal grains had an average size of 6.9 μm and were thus present within a narrow range of 6.0 to 8.0 μm and the crystal grains had a standard deviation of ±1.55 or less, which indicates that crystal grains were grown to a uniform size. In addition, the sintered magnets had a considerably high relative density of 98.3%, which indicates that densification of sintered magnets was sufficiently performed.

### Test Example 2

Analysis of Variation in Microstructures by Scanning Electron Microscopy

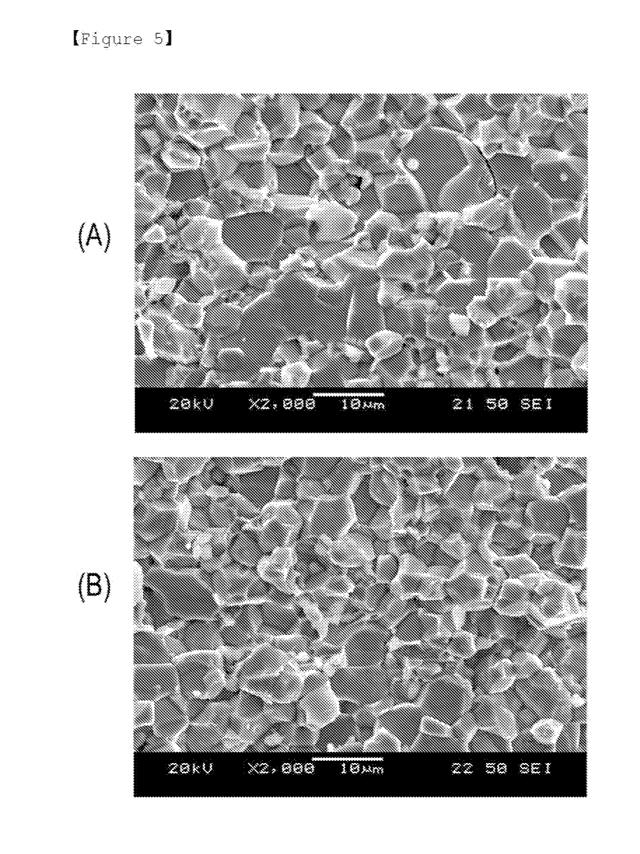

FIG. 5(A) is an SEM (scanning electron microscope) image showing a sintered magnet obtained in Comparative Example 1 and FIG. 5(B) is an SEM image showing a sintered magnet obtained in Example 1.

Referring to FIG. 5, as compared to a general sintering process of Comparative Example 1, the sintered magnet of Example 1 produced according to the present invention formed microstructures in which (Nd,Dy)-rich phases were uniformly distributed in (Nd,Dy)₂Fe₁₄B major phase crystal grain systems. This is due to capillary attraction and compressive stress caused by repetition of heating and cooling within a range from a high temperature to a specific temperature, and, as a result, by thermal expansion and thermal shrinkage between two phases, that is, (Nd,Dy)-rich phase and (Nd,Dy)₂Fe₁₄B crystal grains as a major phase.

### Test Example 3

Analysis of Variation in Microstructures by Scanning Electron Microscopy

In this test example, variation in gap between (Nd,Dy)₂Fe₁₄B phases which cannot be easily observed via scanning electron microscopy was observed using a transmission electron microscope.

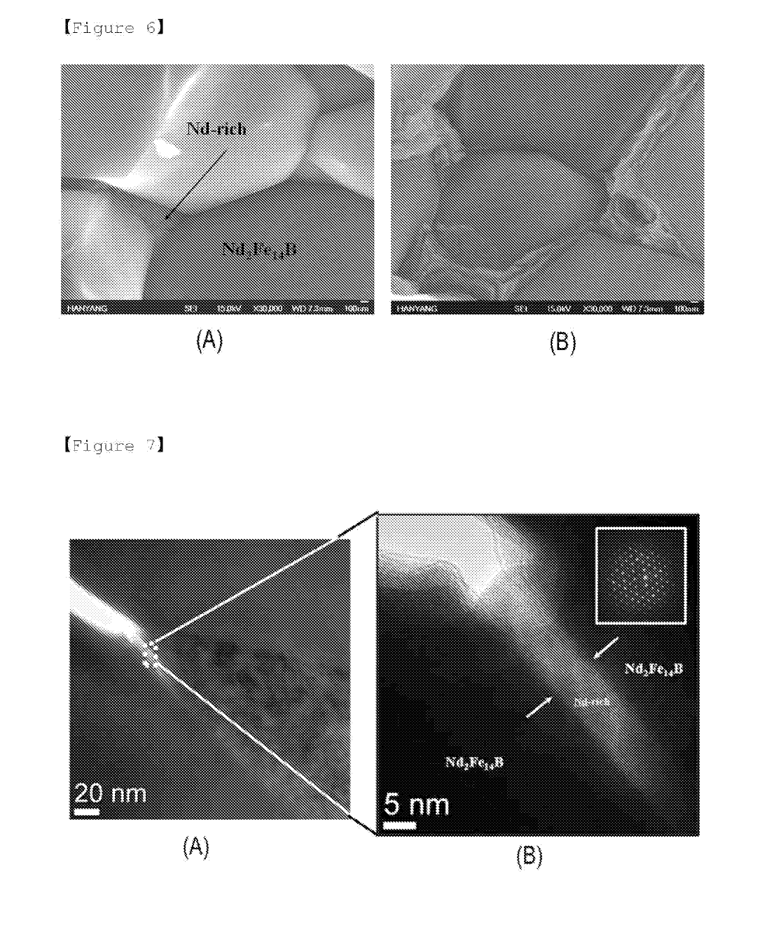

FIG. 6(A) is a TEM (transmission electron microscope) image of a sintered magnet obtained in Comparative Example 1, FIGS. 7(A) and (B) are enlarged transmission electron microscope images of a sintered magnet prepared in Example 1, and FIGS. 8(A) to 8(C) are enlarged transmission electron microscope images of a sintered magnet prepared in Example 1.

Referring to FIGS. 6 and 7, in the sintered magnet produced by a general sintering process of Comparative Example 1, the interfaces between crystal grains were considerably thin or extremely thin such that they could not be observed from the image thereof, and the thickest side thereof had a thickness of about 2 to about 5 nm.

On the other hand, it can be confirmed from FIGS. 6 and 8 that, with respect to the sintered magnet of Example 1 according to the present invention, (Nd,Dy)-rich phases sufficiently surround crystal grains and thickness in the gap between crystal grains excluding triple junctions was about 10 to about 20 nm. Based on this structure in which highly tough (Nd,Dy)-rich phases surround crystal grains, mechanical properties of sintered magnets can be improved.

### Test Example 4

Measurement of Dihedral Angle at Crystal Grain Interface of Sintered Magnets

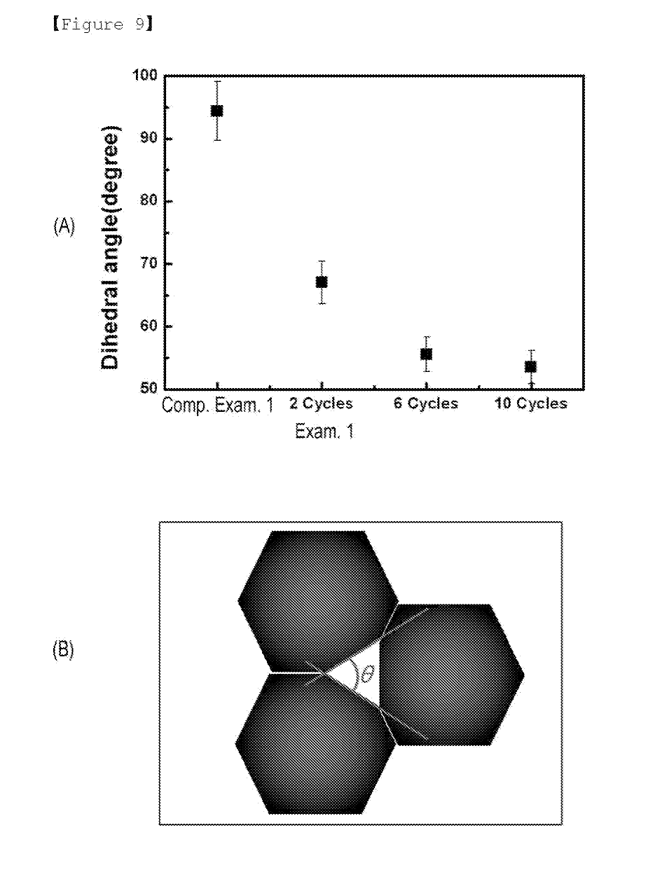

A dihedral angle was measured to confirm variation in microstructures depending on (Nd,Dy)-rich phases. The results thus obtained are shown in FIG. 9.

FIG. 9(A) is a graph showing variation in dihedral angle depending on the cycle number of sintering/thermal treatment processes of Comparative Example 1 and Example 1 and FIG. 9(B) is a schematic view showing a measured region.

As can be seen from FIG. 9(A), the sintered magnet of Comparative Example 1 has a dihedral angle of about 94°, and is rapidly decreased when subjected to cyclic sintering/thermal treatment according to the present invention. Specifically, after 2 cycles (repetitions), a dihedral angle was 67°, after 6 cycles, a dihedral angle was 55°, and after 10 cycles, a dihedral angle was 54°. The decrease in dihedral angle means that (Nd,Dy)-rich phases effectively permeate into crystal grains of (Nd,Dy)₂Fe₁₄B major phase and isolate crystal grains of (Nd,Dy)₂Fe₁₄B major phase and is considered to be an essential parameter to differentiate characteristics of sintered magnets depending on treatment and non-treatment of sintering/thermal treatment.

### Test Example 5

X-Ray Diffraction Analysis of η-Phase in Triple Junction of Sintered Magnet Crystal Grains

X-ray diffraction analysis was performed to confirm microstructures of η-phase present at triple junctions of crystal grains. The results thus obtained are shown in FIG. 10.

FIG. 10 is an X-ray diffraction (XRD) spectrum of sintered magnets prepared by 10 cycles obtained in Example 1. Referring to FIG. 10, the sintered magnet had the following peaks at 20 (20.46, 29.125, 33.344, 33.79, 41.611, 42.494, 44.778, 46.884, 49.949, 54.347, 54.649, 56.864, 61.139, 62.719, 68.521, 70.548, 72.709).

It can be seen from these results that a η-phase (R_{1.1}Fe₄B₄) produced through sintering/thermal treatment was not melted (amorphous) and had a crystalline microstructure.

### Test Example 6

Content of Oxygen in Triple Junction of Sintered Magnets Crystal Grains

The content of oxygen present in (Nd,Dy)-rich phases was measured using an oxygen meter (TC-600, available from LECO Corp.). As a result, R-oxide was present at 3000 ppm or less.

### Test Example 7

Analysis of Microstructure Depending on Cycle Number of Sintering/Thermal Treatment

Sintered magnets were observed by a scanning electron microscope and the size of crystal grains was measured to confirm microstructures of the sintered magnets depending on sintering process conditions.

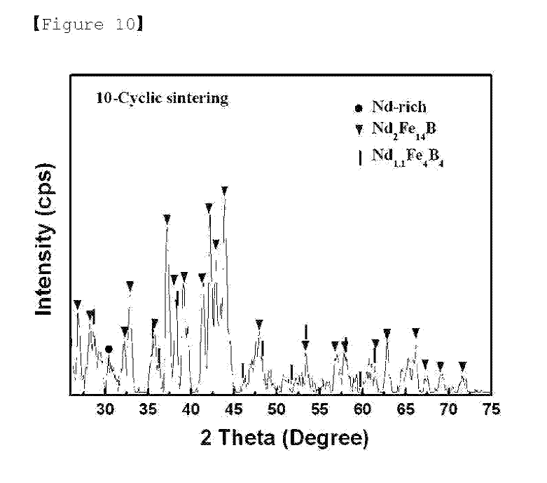

FIG. 11(A) is an image of a sintered magnet produced in Comparative Example 1, FIG. 11(B) is an image of a sintered magnet produced by 2-cycle sintering/thermal treatment, FIG. 11(C) is an image of a sintered magnet produced by 6-cycle sintering/thermal treatment, FIG. 11(D) is an image of a sintered magnet produced by 10-cycle sintering/thermal treatment, and FIG. 12 is a graph showing size and relative density of crystal grains. Herein, white region is in (Nd, Dy)-rich phases, and black region is in (Nd, Dy)₂Fe₁₄B.

As shown in FIGS. 11(A) to 11(D) and FIG. 12, sintered magnets of Comparative Example 1 and Example 1 had relative densities of 98% or higher, and the sintered magnet of Comparative Example 1 had a structure in which (Nd,Dy)-rich phases were locally concentrated at triple junctions.

Also, as can be seen from FIG. 12, depending on the cycle number of sintering/thermal treatment, crystal grains were slightly grown, but were maintained within a range of 6.0 to 8.0 μm.

### Test Example 8

Measurement of Bending Strength According to Sintering/Thermal Treatment

Bending strength was measured in order to confirm improvement in mechanical properties of sintered magnets through sintering/thermal treatment according to the present invention.

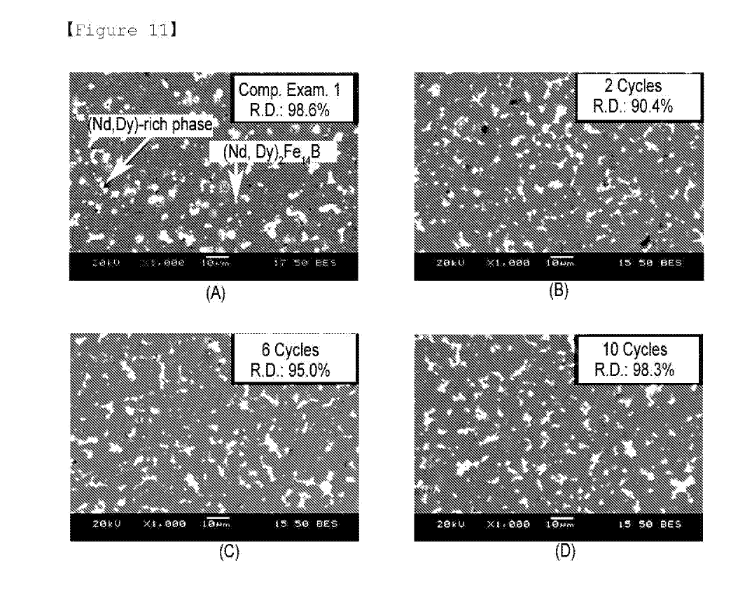

FIG. 13 is a graph showing bending strength of sintered magnets produced in Comparative Example 1 and Example 1. The measurement was carried out by a 3-grade bending test.

Referring to FIG. 13, the sintered magnet of Example 1 exhibited higher bending strengths in all cycles than 1,070° C./4 h of Comparative Example 1. The reason for this is that the sintered magnet of the present invention enables (Nd,Dy)-rich phases to thickly surround crystal grains of (Nd,Dy)₂Fe₁₄B major phase through the sintering/thermal treatment process, suppresses direct contact between the (Nd,Dy)₂Fe₁₄B major phases, reduces stress and blocks propagation of cracks.

### Test Example 9

Measurement of Fracture Toughness

Fracture toughness was measured in order to confirm improvement in mechanical properties of sintered magnets through sintering/thermal treatment according to the present invention.

The fracture toughness was obtained by a Vickers indenter test and propagation length of cracks formed by an indenter was observed using a scanning electron microscope.

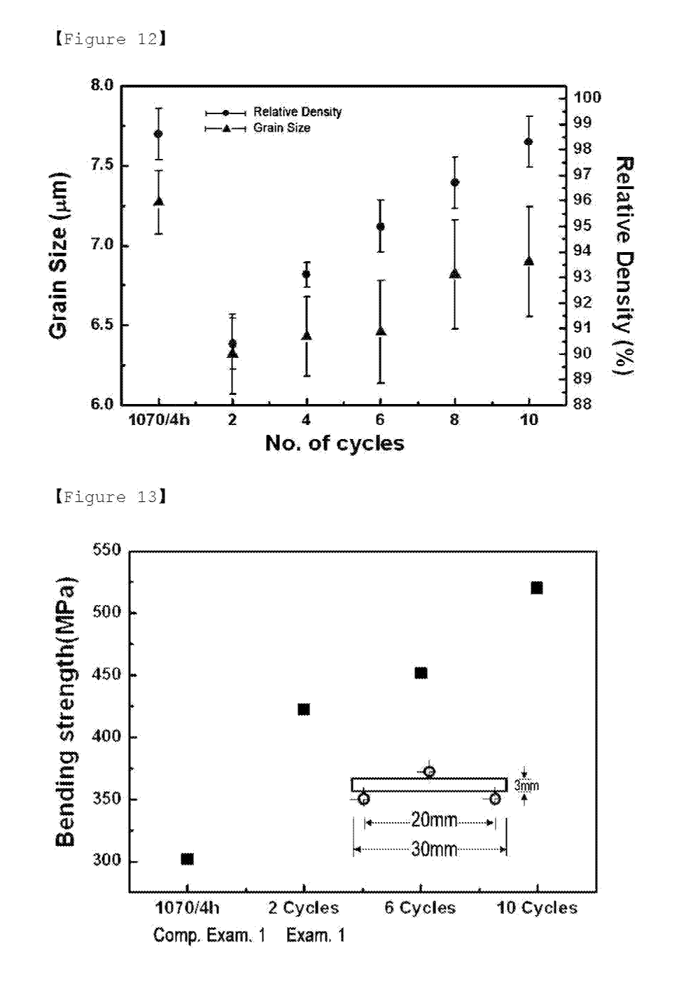

FIG. 14 is a graph showing variation in tensile strength of sintered magnets according to the cyclic sintering/thermal treatment process of Comparative Example 1 and Example 1. FIG. 15 is a scanning electron microscope image showing a propagation length of cracks.

Referring to FIG. 14, the sintered magnets according to the present invention exhibited higher fracture toughness than the sintered magnet of Comparative Example 1 in all cycles. As can be seen from FIG. 15, these results indicate that the sintered magnet of Example 1 had a short crack propagation length and, as the cycle number of sintering/thermal treatment increases, the length also decreases. The reason for increase in fracture toughness is that the sintered material produced by repeated sintering/thermal treatment according to the present invention forms a microstructure in which (Nd,Dy)-rich phases are evenly distributed in an (Nd,Dy)₂Fe₁₄B major phase crystal grain system, and relatively highly tough (Nd,Dy)-rich phases thus absorb stress applied during propagation of cracks.

### Test Example 10

X-Ray Diffraction Analysis

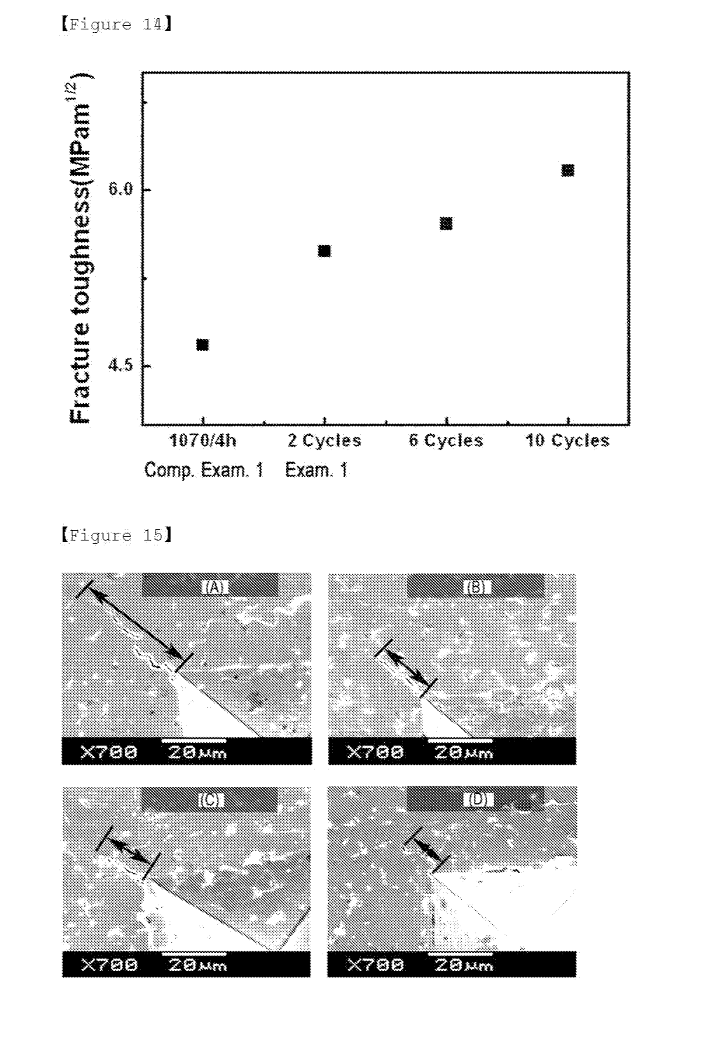

FIG. 16 is X-ray diffraction spectra of sintered magnets produced in Comparative Example 1 and Example 1.

Referring to FIG. 16, since the sintered magnets produced in Comparative Example 1 and Example Thad the same composition, they did not affect the composition ratio of sintered magnets in spite of repeated sintering/thermal treatment.

### Test Example 11

Property of Coercive Force

FIG. 17 is a graph showing variation in coercive force of sintered magnets produced in Comparative Example 1 and Example 1.

It can be seen from FIG. 17 that the sintered magnet of the present invention had a higher tensile strength and a higher coercive force than that of Comparative Example 1.

As a result, the sintered magnet of Example Thad a microstructure in which (Nd,Dy)-rich phases effectively permeate into (Nd,Dy)₂Fe₁₄B crystal grain systems as major phases and are distributed such that the distance between the interface between adjacent R₂Fe₁₄B crystal grains is thicker.

In order words, it can be seen that, through the repeated sintering/thermal treatment process according to the present invention, (Nd,Dy)-rich phases permeate into the interface between (Nd,Dy)₂Fe₁₄B crystal grains, structurally, bending strength and fracture toughness are increased due to the (Nd,Dy)-rich phases, crystal grains of (Nd,Dy)₂Fe₁₄B major phases are effectively isolated from one another, exchange coupling is inhibited and magnetic properties are also improved.

### INDUSTRIAL APPLICABILITY

The sintered magnet of the present invention is utilized in all applications requiring high permanent magnetic properties such as microprecision robot motors, permanent magnets for electric generators, high-reliability permanent magnets for space and air, and motors and permanent magnets that are used at high temperatures or are operated at high magnetic fields, for example, medical machines.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An R—Fe—B (R=Nd, Dy, Pr, Tb, Ho, La, Ce, Sm, Gd, Er, Tm, Yb, Lu or Th) sintered magnet having a structure in which R₂Fe₁₄B crystal grains as major phases are surrounded with R-rich phases,
wherein a dihedral angle between two adjacent R₂Fe₁₄B₂ crystal grains and the R-rich phase contacting the R₂Fe₁₄B₂ crystal grains is 70° or less in a triple junction formed by the R₂Fe₁₄B crystal grains.

2. The R—Fe—B sintered magnet according to claim 1, wherein the dihedral angle is 55° or less.

3. The R—Fe—B sintered magnet according to claim 1, wherein the thickness of R-rich phases present at the interface between the R₂Fe₁₄B crystal grains is 10 nm or more.

4. The R—Fe—B sintered magnet according to claim 1, wherein the thickness of R-rich phases present at the interface between the R₂Fe₁₄B crystal grains is 10 nm to 50 nm.

5. The R—Fe—B sintered magnet according to claim 1, wherein the R-rich phases are present at an area ratio of 5 to 15% with respect to the R₂Fe₁₄ B crystal grains.

6. The R—Fe—B sintered magnet according to claim 1, wherein a crystalline η-phase (R_{1.1}Fe₄B₄) is precipitated and present at the triple junction.

7. The R—Fe—B sintered magnet according to claim 1, wherein the size of the R₂Fe₁₄B crystal grains is 6.0 to 7.0 μm.

8. The R—Fe—B sintered magnet according to claim 6, wherein a standard deviation of an average grain diameter of the R₂Fe₁₄B crystal grains is ±1.55 or less.

9. The R—Fe—B sintered magnet according to claim 1, wherein the sintered magnet has a relative density of 98% or more, a bending strength of 400 to 600 MPa, and a fracture toughness of 5.0 to 7.0 MPa·m^{1/2}.

10. The R—Fe—B sintered magnet according to claim 1, wherein the sintered magnet has a coercive force of 8 to 36 kOe.

11. The R—Fe—B sintered magnet according to claim 1, wherein the R—Fe—B sintered magnet is a Rₓ—Fe_{y}—B_{z} (x=11.8 to 15.5, y=100−(x+z), z=5.8 to 6.2, at %) sintered magnet.

12. The R—Fe—B sintered magnet according to claim 1, wherein a part of Fe in the R—Fe—B sintered magnet is substituted at an amount of 0.01 to 3.0 at % by at least one selected from the group consisting of Co, Cu, Ni, Al, Si, Ti, V, Cr, Mn, Zn, Ga, Zr, Nb, Mo, Ag, In, Sn, Hf, Ta, W, Pb and Bi.

13. The R—Fe—B sintered magnet according to claim 1, wherein the surface of the R—Fe—B sintered magnetis further plated with a thin film.

14. A method for producing the R—Fe—B sintered magnet according to claim 1 by sintering and thermal treatment using a R—Fe—B (R=Nd, Dy, Pr, Tb, Ho, La, Ce, Sm, Gd, Er, Tm, Yb, Lu, Th) powder,
wherein the sintering and the thermal treatment are repeated two or more times.

15. The method according to claim 14, wherein the sintering is carried out at 1050 to 1200° C. and the thermal treatment is carried out at 750 to 1000° C.

16. The method according to claim 14, wherein the difference between the sintering temperature and the thermal treatment temperature is 70° C. or more.

17. The method according to claim 14, wherein the sintering and the thermal treatment are carried out at a thermal treatment rate and a cooling rate of 5 to 15° C./min, respectively.

18. The method according to claim 14, wherein the sintering and thermal treatment processes are performed until a theoretical density of the sintered magnet is 98% or more.

19. The method according to claim 14, wherein, after sintering of the R—Fe—B powder, R₂Fe₁₄B crystal grains of the sintered magnet are grown to a size of 150% or less.
